(19) United States
(12) Patent Application Publication
(10) Pub. No.: US 2003/0041522 A1
(43) Pub. Date: Mar. 6, 2003

(54) Closer for a sliding door

(76) Inventor: Roderick William Cauchon, Carlsbad, CA (US)

Correspondence Address: NEIL K. NYDEGGER, NYDEGGER & ASSOCIATES, 348 Olive Street, San Diego, CA, 92103, US

(21) Appl. No.: 09/944,539

(22) Filed: Aug. 31, 2001

(51) Int. Cl. E06B 3/34

(52) U.S. Cl. 49/404

(57) ABSTRACT

A self-closing system for a screen door that slides in a doorway includes an elongated tube for attachment to the rear stile of the sliding door in a substantially vertical orientation. A housing that contains an internal pulley is attached to the top end of the tube. A cable is provided having a first end for attachment to the front jamb of the doorway. From the doorway, the cable extends into the housing and runs around the pulley. From the pulley, the cable exits the housing and extends into the tube where the second end of the cable is connected to a weight. The weight is movable within the tube to maintain a constant tension on the cable. The cable tension, in turn, applies a force on the pulley and housing. This force acts to bias the sliding door into a closed position.

### FIELD OF THE INVENTION

The present invention pertains generally to sliding doors and windows. More particularly, the present invention pertains to self-closing systems for sliding doors and windows. The present invention is particularly, but not exclusively, useful as a sliding screen door having a gravity actuated self-closing system.

### BACKGROUND OF THE INVENTION

Almost all modern homes have sliding glass doors, often providing access to a patio or backyard. Accompanying these sliding glass doors is a screen door that is provided to allow air to flow into the home, while preventing flies and other insects from entering the home. Although most modern screen doors have rollers along the bottom of the door to allow the screen door to roll along a track during opening and closing, these type of screen doors are still referred to as sliding doors. Generally, light weight screen doors are preferred, since they require less effort to open and close.

A typical screen door is constructed of a screen and a frame that surrounds and holds the screen. The frame is usually constructed from a top horizontal member, a bottom horizontal member, and front and rear stiles that extend vertically to connect the top and bottom horizontal members together. These frame members are generally extruded from aluminum and have a hollow design to save weight and raw material costs. To assemble the screen door frame from the frame members, the members can be welded or bonded together, or attached to each other using connectors. Once assembled, the screen door is installed in a doorway having a threshold at the bottom, a lintel at the top and front and rear jambs. The front and rear jambs extend vertically to connect the threshold to the lintel. With this nomenclature, the screen door is closed when the front stile is adjacent to the front jamb and open when the front stile is separated from the front jamb.

As indicated above, a closed screen door allows air to enter a home, while keeping out unwanted insects. In addition, a closed screen door can function to keep pets in (or out) of a home, and can keep infants and toddlers inside the home. This is especially important when a pool, barbecue or some other potential hazard is present in the backyard. Of course, through diligent effort, a screen door can be kept closed, nearly all the time. Still, it would be convenient, as well as safer, to have a self-closing screen door.

In light of the above, it is an object of the present invention to provide a self-closing screen door that is lightweight. It is another object of the present invention to provide a self-closing screen door that is aesthetically pleasing in that most of the components of the self-closing system are encapsulated in a standard screen door frame, and thus, hidden from view. It is yet another object of the present invention to provide a self-closing screen door which is easy to use, relatively simple to implement, and comparatively cost effective.

### SUMMARY OF THE PREFERRED EMBODIMENTS

The present invention is directed to self-closing systems for sliding doors and windows. In one embodiment of the present invention, the system is designed to be easily installed onto a pre-existing sliding door to convert the door into a self-closing door. In another embodiment, the self-closing system is designed to be an integral part of the sliding door. In both embodiments, a weight and cable (string) assembly is used to provide the force necessary to close the door.

When the self-closing system of the present invention is configured for installation on a pre-existing sliding door, the system includes an elongated tube that defines a longitudinal axis in the direction of tube elongation. The tube is formed with holes for mounting the tube to the exterior surface of the rear stile of the sliding door with mounting screws. When the tube is mounted on the rear stile, the longitudinal axis of the tube extends in a substantially vertical direction. When mounted on the rear stile, the tube has an open top end and an open bottom end.

A housing that is formed as a substantially cylindrical wall that surrounds a chamber is attached to the top end of the tube. With this combination of structure, the chamber of the housing is in communication with the inside of the tube. For the present invention, the housing is formed with a passageway that extends radially through the cylindrical wall of the housing. From the chamber, the passageway extends toward the front jamb of the doorway and is aligned with a substantially horizontal direction. Thus, a pathway is provided from the front jamb of the doorway to the inside of the tube that passes through the passageway and chamber of the housing.

For the present invention, a pulley is disposed within the chamber of the housing and mounted to the wall of the housing for rotation about a rotation axis that is substantially perpendicular to the plane of the sliding door. Specifically, the pulley includes a wheel that is mounted on a shaft. Each end of the shaft is affixed to the wall of the housing, and the wheel is rotatable about the shaft. Preferably, the rim of the wheel is formed with a groove to allow a cable (string) under tension to run over the wheel without slipping off the wheel.

The self-closing system of the present invention further includes a cable having a first end and a second end. The first end of the cable is attached to the front jamb of the doorway. From the doorway, the cable extends through the passageway of the housing and into the chamber of the housing. In the housing, the cable runs around the pulley, then exits the housing through the chamber. From the chamber of the housing, the cable extends into the tube. As such, the second end of the cable is disposed in the tube.

Inside the tube, a weight is attached to the second end of the cable. The weight is movable within the tube to maintain a constant tension on the cable as the door slides. As the door is opened, the weight is pulled upward within the tube. When the person opening the door releases the door, the weight falls within the tube, maintaining a tension on the cable. The cable tension, in turn, applies a force on the pulley (and the housing). Importantly, a component of the force that acts on the pulley is directed towards the front jamb. This force component acts to bias the sliding door into a closed position.

When the self-closing system of the present invention is configured as an integral part of the sliding door, the frame of the sliding door includes a hollow rear stile and a hollow top member. A guide connector is provided to attach the top member to the rear stile. In detail, the guide connector has a hollow body portion and two hollow extensions that each project from the body portion. The extensions project in relative directions that are separated from each other by approximately ninety degrees. The first hollow extension is for attachment to the rear stile while the second hollow extension is for attachment to the top member. With this structure, a continuous passageway is formed that extends from the inside of the top member to the inside of the rear stile.

Like the system configured for installation on a pre-existing sliding door, when the system is configured as an integral part of the sliding door, a pulley is provided. Specifically, a pulley is disposed within the hollow body of the guide connector and aligned for rotation about a rotation axis that is substantially perpendicular to the plane of the sliding door.

In addition to the guide connector for attaching the top member to the rear stile, the system includes a modified front connector for attaching the top member to the front stile. In detail, the front connector has a body portion and two extensions that project from the body portion. The extensions project in relative directions that are separated from each other by approximately ninety degrees. The first extension attaches the front connector to the front stile while the second extension attaches the front connector to the top member. Importantly, the front connector is formed with a hole that extends through the body portion and the second extension. More specifically, the hole extends from the outside surface of the body portion at one end of the hole and through the second extension on the other end of the hole. With this structure, the front connector provides a continuous passageway that extends from the outside surface of the sliding door to the inside of the top member.

The system configured as an integral part of the sliding door further includes a cable having a first end and a second end. The first end of the cable is attached to the front jamb of the doorway. From the doorway, the cable extends through the passageway in the front connector and into the hollow top member. From the top member, the cable extends into the guide connector, where the cable runs around the pulley. From the pulley, the cable exits the guide connector and extends into the hollow rear stile. Thus, the second end of the cable is disposed within the rear stile.

Inside the rear stile, a weight is attached to the second end of the cable. The weight is movable within the hollow rear stile to maintain a constant tension on the cable as the door slides. As the door is opened, the weight is pulled upward within the rear stile. When the person opening the sliding door releases the door, the weight falls within the rear stile, maintaining a tension on the cable. The cable tension, in turn, applies a force on the pulley (and the guide connector). Importantly, a component of the force that acts on the pulley is directed towards the front jamb. This force component acts to bias the sliding door into a closed position.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a door closing system in accordance with the present invention installed on a pre-existing sliding door;

FIG. 2 is a sectional view of the door closing system shown in FIG. 1 as seen along line 2-2 in FIG. 1;

FIG. 3 is an exploded, perspective view of a housing and pulley assembly in accordance with the present invention;

FIG. 4 is an elevation view of a door closing system in accordance with the present invention installed on a pre-existing sliding door, showing the position of the weight when the door is open and the position of the weight when the door is closed;

FIG. 5 is a perspective view of a sliding door containing a door closing system that is configured as an integral part of the sliding door;

FIG. 6 is a sectional view of a portion of the sliding door shown in FIG. 5 as seen along line 6-6 in FIG. 5 showing the cooperative interaction between the rear stile, top member and guide connector of the present invention; and

FIG. 7 is a sectional view of a portion of the sliding door shown in FIG. 5 as seen along line 7-7 in FIG. 5 showing the cooperative interaction between the front stile, top member and front connector of the present invention.

### DESCRIPTION OF THE PREFERRED EMBODIMENT

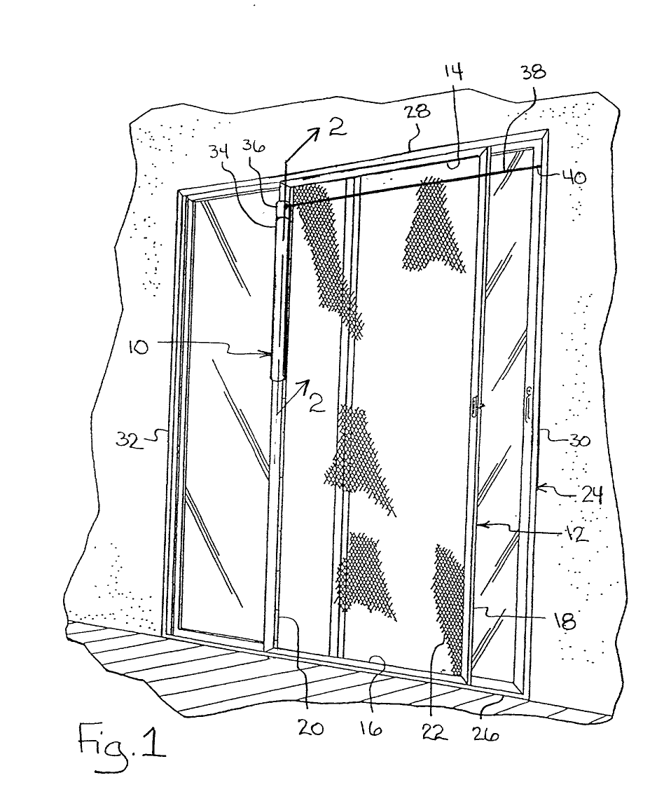

Referring to FIG. 1, a door closer system 10 is shown installed on a preexisting sliding screen door 12. As shown in FIG. 1, the screen door 12 includes a frame having a top member 14, a bottom member 16, a front stile 18, and a rear stile 20. As further shown, the frame surrounds and holds a screen 22. The screen door 12 is positioned in a doorway 24 that includes a threshold 26, lintel 28, front jamb 30 and rear jamb 32. It is to be appreciated that within the doorway 24, the screen door 12 is able to slide back and forth. It is to be further appreciated from FIG. 1 that the screen door 12 is closed when the front stile 18 is adjacent to the front jamb 30. In FIG. 1, an open screen door 12 is shown, and accordingly, the front stile 18 is distanced from the front jamb 30.

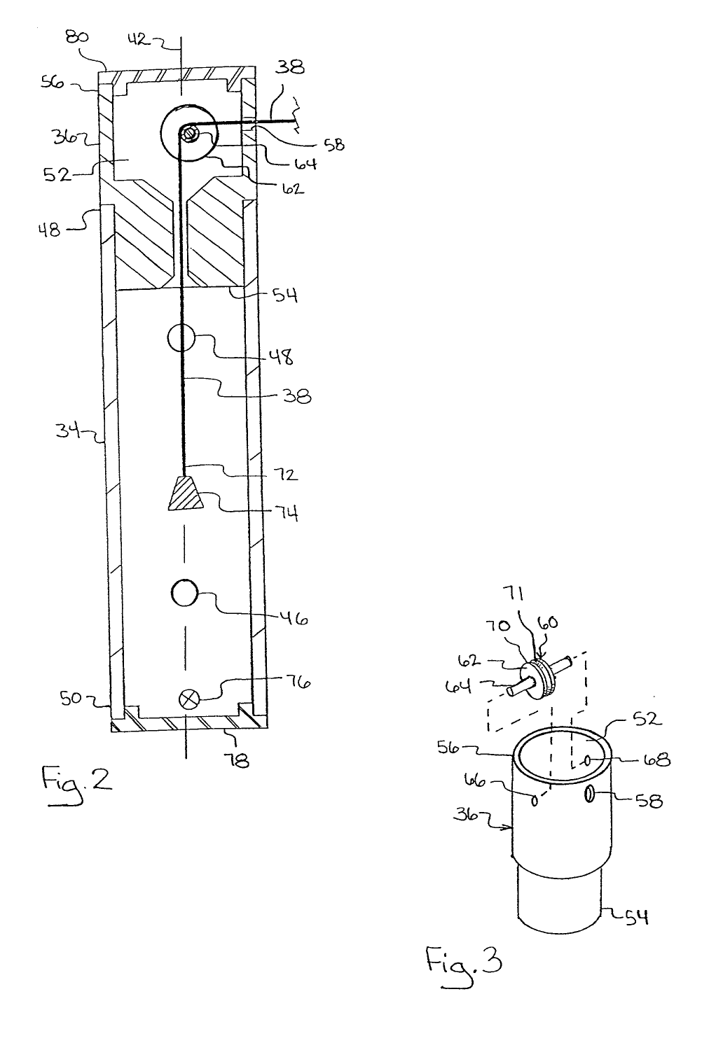

Continuing with FIG. 1 for the moment, it can be seen that the door closing system 10 includes a tube 34 and housing 36 that are mounted on the rear stile 20 of the screen door 12. As further shown, a cable (string) 38 emanates from the housing 36 and is attached to the front jamb 30 of the doorway 24 at an end 40 of the cable 38. A better understanding of the interactive cooperation between the tube 34, housing 36 and cable 38 can be obtained with cross reference to FIGS. 1 and 2. As shown, the tube 34 is preferably shaped as an elongated cylinder that defines a longitudinal axis 42 in the direction of elongation. The tube 34 is formed with holes 44, 46 for mounting the tube 34 to the rear stile 20 of the sliding door 12 with mounting screws (screws not shown). Continuing with cross reference to FIGS. 1 and 2 it can be seen that the tube 34 is mounted on the rear stile 20 with the longitudinal axis 42 of the tube 34 extending in a substantially vertical direction. With this vertical orientation, the tube 34 has an open top end 48 and an open bottom end 50.

In the preferred embodiment of the present invention, the housing 36 is formed as a substantially cylindrical wall that surrounds a chamber 52, as shown in FIGS. 2 and 3. As shown, the outer diameter of end 54 of the cylindrical housing 36 is reduced relative to the end 56 of the housing 36, allowing the reduced diameter end 54 of the housing 36 to be inserted into the top end 48 of the tube 34. Preferably, an interference fit is provided between the top end 48 of the tube 34 and the reduced diameter end 54 of the housing 36 to prevent relative movement between the housing 36 and tube 34 when the housing 36 is attached to the tube 34. In some embodiments, a fastener (not shown) or an adhesive (not shown) can be used to secure the housing 36 to the tube 34.

As best seen in FIG. 2, when the housing 36 is secured to the tube 34, the chamber 52 of the housing 36 is in communication with the inside of the tube 34 allowing the cable 38 to pass from the chamber 52 of the housing 36 to the inside of the tube 34. As further shown, the housing 36 is formed with a passageway 58 that extends radially through the cylindrical wall of the housing 36. With this passageway 58, the cable 38 is able to exit from the housing 36. With cross reference to FIGS. 1 and 2, it can be seen that from the chamber 52, the passageway 58 extends toward the front jamb 30 of the doorway 24, and is aligned with a substantially horizontal direction. With this cooperation of structure, a continuous pathway is provided from the front jamb 30 of the doorway 24 to the inside of the tube 34 that extends through the passageway 58 and chamber 52 of the housing 36.

With cross reference to FIGS. 2 and 3, it can be seen that a pulley assembly 60 is disposed within the chamber 52 of the housing 36 and mounted to the wall of the housing 36. In more detail, the pulley assembly 60 includes a wheel 62 that is rotatable about a shaft 64. Referring to FIG. 3, it can be seen that holes 66, 68 are provided in the wall of the housing 36 to allow the shaft 64 to be secured to the housing 36. An adhesive (not shown) can be used to secure the shaft 64 to the housing 36 and thereby prevent relative movement between the shaft 64 and the housing 36. With cross reference to FIGS. 1 and 2, it can be seen that the wheel 62 rotates about a rotation axis that is substantially perpendicular to the plane of the sliding door 12. As best seen in FIG. 3, the rim 70 of the wheel 62 is preferably formed with a groove 71 to prevent the cable 38 (shown in FIGS. 1 and 2) from slipping off the wheel 62.

With cross reference now to FIGS. 1 and 2, it can be seen that the cable 38 has an end 40 and an end 72. As shown, the end 40 of the cable 38 is attached to the front jamb 30 of the doorway 24. From the front jamb 30, the cable 38 extends across the sliding door 12 and towards the rear stile 20 of the door 12. Near the rear stile 20, the cable 38 extends through the passageway 58 of the housing 36 and into the chamber 52 of the housing 36. In the housing 36, the cable 38 runs around the wheel 62 of the pulley assembly 60. From the wheel 62, the cable 38 exits the end 54 of the housing 36 and extends into the tube 34. Inside the tube 34, the cable 38 terminates in an end 72.

As shown in FIG. 2, a weight 74 is disposed inside the tube 34 and attached to the end 72 of the cable 38. As shown, the weight 74 is free to move within the tube 34, and thus, maintains a constant tension on the cable 38. It is to be appreciated that the weight 74 shown is only exemplary and that the size and mass of the weight 74 can be varied depending on the weight and sliding characteristics of the door 12 (door 12 shown in FIG. 1). An optional stop 76 can be installed in the tube 34 near the end 50 to limit downward travel of the weight 74. If desired, caps 78, 80 can be installed on the tube 34/housing 36 assembly to seal the assembly from dust and other contaminants that may affect the operation of the assembly.

The operation of the door closing system 10 can best be appreciated with reference to FIG. 4. In detail, FIG. 4 shows the state of the system 10 when the sliding door 12 is closed (solid lines) and the state of the system 10 when the sliding door 12 is open (dashed lines). From FIG. 4 it can be seen that as the door 12 is slid open, the weight 74 is pulled upward within the tube 34. When the person opening the door (person not shown) releases the door 12, the weight 74 falls within the tube 34, maintaining a tension of the cable 38. The tension on the cable 38, in turn, applies a force on the wheel 62 (and the housing 36). Importantly, a component of the force acting on the wheel 62 from the cable 38 is directed towards the front jamb 30 of the doorway 24. This force component acts to bias the sliding door 12 into a closed position.

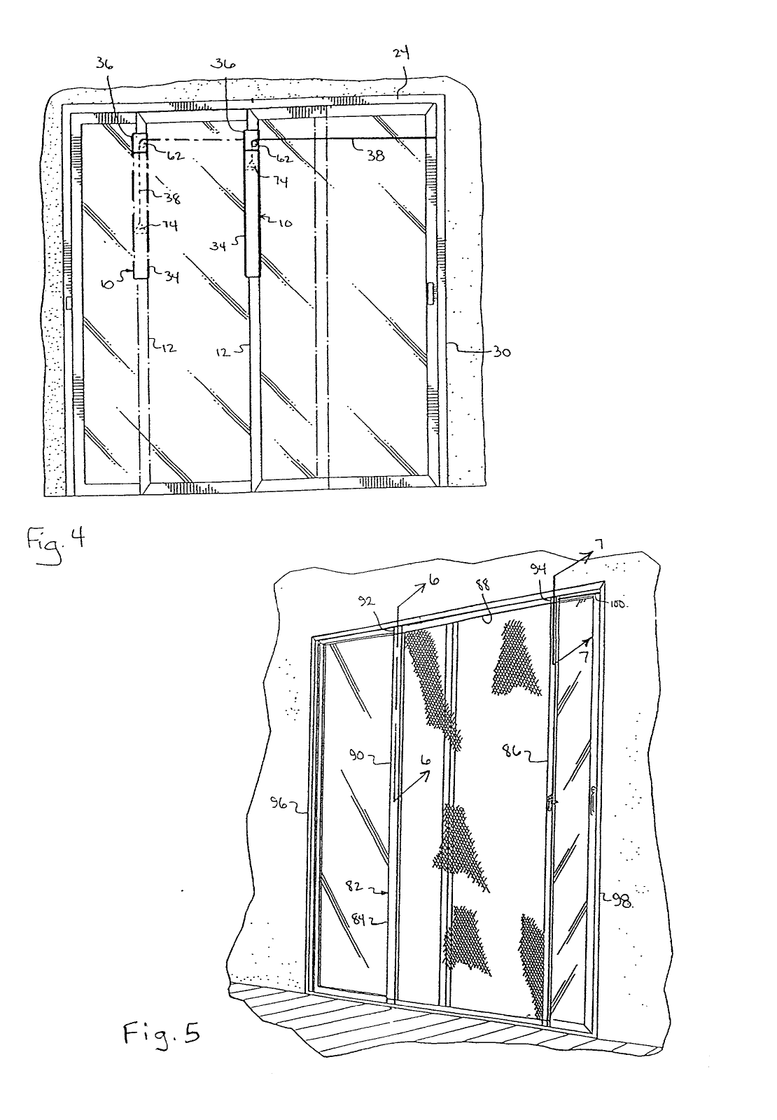

FIGS. 5-7 show a sliding door 82 containing an integral door closing mechanism in accordance with the present invention. Referring initially to FIG. 5, it can be seen that the sliding door 82 has a frame 84 that includes a front stile 86, top member 88 and rear stile 90. As further shown, a guide connector 92 is provided to attach the rear stile 90 to the top member 88 and a front connector 94 is provided to attach the front stile 86 to the top member 88. it is also to be appreciated from FIG. 5 that the sliding door 82 slides back and forth within a doorway 96 that has a front jamb 98. It is further apparent from FIG. 5 that the sliding door 82 is closed when the front stile 86 is adjacent to the front jamb 98.

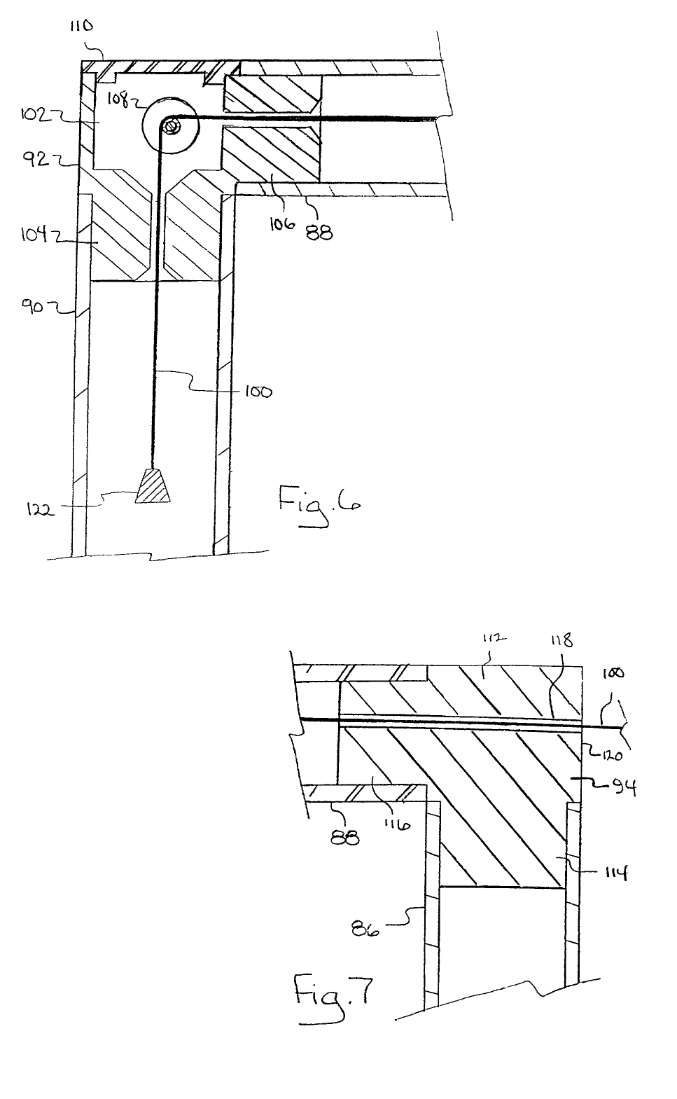

Referring now with cross reference to FIGS. 5 and 6 it can be seen that both the rear stile 90 and the top member 88 are hollow allowing a cable (string) 100 to extend within both the rear stile 90 and the top member 88. As further shown, the rear stile 90 is attached to the top member 88 by the guide connector 92. In detail, the guide connector 92 has a hollow body portion 102 from which a hollow extension 104 and a hollow extension 106 project. As shown, the extensions 104, 106 project in relative directions that are separated from each other by approximately ninety degrees. From FIG. 6 is can be seen that hollow extension 104 is attached to the rear stile 90 while the hollow extension 106 is attached to the top member 88. With this structure, a continuous passageway is formed that allows cable 100 to extend from the inside of top member 88 to the inside of the rear stile 90. Preferably, as shown, a pulley assembly 108 is disposed within the hollow body portion 102 of the guide connector 92 to reduce friction on the cable 100 as the cable 100 travels through the guide connector 92. With cross reference to FIGS. 5 and 6 it can be seen that the pulley assembly 108 is aligned for rotation about a rotation axis that is substantially perpendicular to the plane of the sliding door 82. A cap 110 can be provided to prevent dust and other contaminants from interfering with the operation of the guide connector 92.

With cross reference now to FIGS. 5 and 7, is can be seen that the front connector 94 attaches the hollow top member 88 to the front stile 86. Although a hollow front stile 86 is shown, it is to be appreciated that a hollow front style 86 is not necessarily required for the present invention. Rather, when a non-hollow front style 86 is used, the front connector 94 can be modified, using methods known in the pertinent art, to provide a connection between the non-hollow front style 86 and the top member 88. Referring now to FIG. 7, it can be seen that the front connector 94 has a body portion 112 from which extension 114 and extension 116 project. As shown, the extensions 114, 116 project in relative directions that are separated from each other by approximately ninety degrees. As further shown, extension 114 is attached to the front stile 86 while the extension 116 is attached to the top member 88. Importantly for the present invention, the front connector 94 is formed with a hole 118 that extends through the body portion 112 and extension 116. More specifically, the hole 118 extends from the outside surface 120 of the body portion 112 at one end and through the extension 116 on the other end. With this structure, the front connector 94 provides a continuous passageway that extends from the outside surface of the sliding door 82 to the inside of the top member 88.

With cross reference to FIGS. 5-7, it can be seen that the one end of the cable 100 is attached to the front jamb 98 of the doorway 96. From the front jamb 98, the cable 100 extends through the hole 118 in the front connector 94 and into the hollow top member 88. From the top member 88, the cable 100 extends into the guide connector 92, where the cable 100 runs around the pulley assembly 108. From the pulley assembly 108, the cable 100 exits the guide connector 92 and extends into the hollow rear stile 90. Inside the hollow rear stile 90, the cable 100 is attached to a weight 122. Importantly, the weight 122 is movable within the hollow rear stile 90 to maintain a constant tension on the cable 100 as the door 82 slides. It is to be appreciated that as the door 82 is opened, the weight 122 is pulled upward within the rear stile 90. When the opening force is released, the weight 122 falls within the rear stile 90, maintaining a tension of the cable 100. The cable tension, in turn, applies a force acting on the pulley assembly 108 and the guide connector 92. Importantly, a component of the force on the pulley assembly 108 from the cable 100 is directed towards the front jamb 98 of the doorway 96. This force component acts to bias the sliding door 82 into a closed position.

While the particular Closer for a Sliding Door as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A gravity actuated door closing system for use with a sliding door assembly having a doorway that defines a plane and includes front and rear jambs, and a sliding door having front and rear stiles that is disposed in said doorway to slide in said plane of said doorway, said front stile of said sliding door being adjacent said front jamb of said doorway when said sliding door is closed, said door closing system comprising:
an elongated tube;
means for mounting said tube to said rear stile in a substantially vertical orientation;
a housing formed as a substantially cylindrical wall that surrounds a chamber, said housing having a radial passageway extending through said wall, said housing being attached to said top end of said tube with said chamber in communication with the inside of said tube and said radial passageway aligned substantially parallel to the plane of said doorway;
a pulley disposed within said chamber of said housing and mounted to said wall of said housing for rotation about a rotation axis that is substantially perpendicular to said plane of said doorway frame;
a cable having a first end for attachment to said front jamb and a second end, said cable being extendable through said radial passageway, said chamber of said housing, and a portion of said tube; and
a weight disposed is said tube and attached to said second end of said cable, said weight being movable within said tube to maintain a tension on said cable, said cable tension for applying a force on said pulley and said housing to bias said door into a closed position.

2. A door closing system as recited in claim 1 wherein said wall of said housing is formed with open ends, and wherein said door closing system further comprises a cap to cover one said open end.

3. A door closing system as recited in claim 1 further comprising:
a cable guide; and
a means for mounting said cable guide on said front stile of said sliding door to guide said cable between said front jamb of said doorway and said housing.

4. A door closing system as recited in claim 1 wherein said tube has a bottom end when mounted on said rear stile in a vertical orientation and wherein said door closer assembly further comprising a bottom cap to cover said bottom end of said tube.

5. A door closing system as recited in claim 1 wherein said tube is formed with a hole and said means for mounting said tube on said rear stile comprises a mounting screw engageable with said hole.

6. A door closing system as recited in claim 1 further comprising a stop disposed within said tube to limit downward travel of said weight.

7. A door closing system as recited in claim 1 further comprising a hook secured to said first end of said cable and an eyelet for attachment to said front jamb of said doorway, said hook and said eyelet for removably attaching said cable to said front jamb to allow the door closing system to be temporarily disabled.

8. A door closing system as recited in claim 1 wherein said pulley comprises a shaft having a first end, and a second end, and a wheel disposed on said shaft for rotation about said shaft, and wherein said first end and said second end of said shaft are attached to said wall of said housing.

9. A door closing system as recited in claim 8 wherein said wheel of said pulley is formed with a rim and said rim is grooved to prevent said cable from slipping off said wheel when said cable is under tension.

10. A self-closing, sliding screen door assembly comprising:
a screen;
a plurality of elongated frame members including a top member and a hollow stile;
a plurality of connectors for attaching said plurality of elongated frame members together to establish a frame around said screen, said plurality of connectors including a guide connector for attaching said top member to said hollow stile, said guide connector formed with a passageway;
a cable extendable through said passageway of said guide connector and a portion of said hollow stile, said cable having a first end for attachment to a structure fixed in position relative to said sliding screen door assembly, and a second end; and
a weight disposed in said hollow stile and attached to said second end of said cable, said weight being movable within said hollow stile to maintain a tension on said cable, said cable tension applying a force on said guide connector to bias said sliding screen door assembly into a closed position.

11. A sliding screen door assembly as recited in claim 10 wherein said hollow stile is a rear stile.

12. A sliding screen door assembly as recited in claim 11 wherein said plurality of connectors includes a front connector formed with a passageway and said plurality of elongated frame member includes a front stile, said front connector for attaching said top piece to said front stile, and wherein said top piece is hollow and said cable passes from said guide connector, inside said top piece, and through said passageway in said front connector to said structure fixed in position relative to said sliding screen door assembly.

13. A sliding screen door assembly as recited in claim 10 wherein said sliding screen door assembly further comprises a pulley disposed in said passageway of said guide connector for contact with said cable.

14. A sliding screen door assembly as recited in claim 10 wherein said pulley comprises a shaft having a first end, a second end and defining a shaft axis and a wheel disposed on said shaft for rotation about said shaft axis, and wherein said first end and said second end of said shaft are attached to said guide connector.

15. A sliding screen door assembly as recited in claim 14 wherein said wheel of said pulley is formed with a rim and said rim is grooved to prevent said cable from slipping off said wheel when said cable is under tension.

16. A self-closing, sliding screen door for use in a doorway having a front and rear jamb, said sliding screen door comprising:
a screen;
a plurality of elongated frame members including a hollow top member, a front stile and a hollow rear stile;
a plurality of connectors for attaching said plurality of elongated frame members together to establish a frame around said screen, said plurality of connectors including a front connector formed with a passageway for attaching said top member to said front stile, and a guide connector formed with a passageway for attaching said top member to said rear stile;
a cable having a first end for attachment to said front jamb and a second end, said cable being extendable through a portion of said rear stile, through said passageway of said guide connector, through said hollow top member and through said passageway of said front connector;
a pulley disposed in said passageway of said guide connector for engagement with said cable; and
a weight disposed is said rear stile and attached to said second end of said cable, said weight being movable within said rear stile to maintain a tension on said cable, said cable tension applying a force on said guide connector to bias said front stile of said sliding screen door toward said front jamb of said doorway.

17. A sliding screen door as recited in claim 16 wherein said pulley comprises a shaft having a first end, a second end and defining a shaft axis and a wheel disposed on said shaft for rotation about said shaft axis, and wherein said first end and said second end of said shaft are attached to said guide connector.

18. A sliding screen door as recited in claim 17 wherein said wheel of said pulley is formed with a rim and said rim is grooved to prevent said cable from slipping off said wheel when said cable is under tension.

19. A sliding screen door as recited in claim 16 further comprising a hook secured to said first end of said cable and an eyelet for attachment to said front jamb, said hook and said eyelet for allowing said cable to be removably attached to said front jamb to temporarily prevent said sliding screen door from self-closing.

20. A sliding screen door as recited in claim 16 further comprising a stop mounted in said rear stile to limit downward travel of said weight.
